(19) United States
(12) Patent Application Publication
(10) Pub. No.: US 2012/0247252 A1
(43) Pub. Date: Oct. 4, 2012

(54) ENCLOSING SHIFT CONTROL DEVICE FOR A BICYCLE TRANSMISSION

(76) Inventor: Wei-Hsuan CHANG, Taichung City (TW)

(21) Appl. No.: 13/075,193

(22) Filed: Mar. 30, 2011

(51) Int. Cl. B62M 25/04

(52) U.S. Cl. 74/473.3

(57) ABSTRACT

An enclosing shift control device for a bicycle transmission is set up by an enclosing casing enclosing a bicycle handle. Through the enclosing shift control device, a rider only turns an operating casing to shift bicycle transmissions from one gear ratio to another.

### BACKGROUND OF THE INVENTION

1. Field of the Invention

The present invention relates to a bicycle transmission and more particularly to a shift control device for a bicycle transmission which makes riders shift bicycle transmissions from one gear ratio to another easily.

2. Description of Related Art

A conventional shift control device comprises a supporting device. The supporting device has a circle base and a coaxial axle extended from the circle base. The circle base is assembled to a bicycle handle. A wire spooling device pivoted on the coaxial axle is adapted to wind or unwind a transmission control wire. An adjusting device has an engaging member thereof for adapting to orient the wire spooling device. First and second levers that operate the wire spooling device, wherein the first lever is moved from a rest position to an operating position to wind the transmission control wire around the wire spooling device, and the second lever is moved from a rest position to an operating position to unwind the transmission control wire from the wire spooling device. A transmission device has a driving member mounted to the first lever, wherein the driving member drives the first lever for winding the transmission control wire. When the wire spooling device rotates freely to unwind the transmission control wire, the rotation of the wire spooling device is paused by the driving member. Through an interaction between the first and second levers, the adjusting device, and the transmission device, bicycle transmissions are able to be shifted from one gear ratio to another.

When a rider uses the conventional shift control device to shift bicycle transmissions from one gear ratio to another, the rider has to release one hand from a bicycle handle to operate the first and second lever. This is not safe for the rider riding on the road.

The present invention has arisen to mitigate and/or obviate the disadvantages of the conventional

### SUMMARY OF THE INVENTION

The main objective of the present invention is to provide an improved shift control device for a bicycle transmission.

To achieve the objective, an enclosing casing is adapted to enclose the bicycle handles. The enclosing casing has a covering base, wherein the covering base is formed by unfolding one end of the enclosing casing inside out. The covering base has a wire base adapted to providing a control wire through the covering base. A plurality of unidirectional teeth circumferentially aligned around an inner peripheral surface of the covering base.

An operating casing is adapted to enclose and rotate around the enclosing casing freely. The operating casing has a functional base at one end of the operating casing corresponding to the covering base. An accommodating space is formed by the covering base enclosing the functional base. A clockwise driving rib is formed on the functional base. A counterclockwise driving rib is formed on the functional base. A releasable rib is formed on the functional base.

An adjusting ring is adapted to connect with the control wire within the accommodating space. The adjusting ring has a positioning device thereof for adapting to be rotated by the clockwise driving rib clockwise relative to the enclosing casing. The adjusting ring has an elastic hook attached to the counterclockwise driving rib. The elastic hook resists and slows down the counterclockwise driving rib rotating counterclockwise around the enclosing casing relatively. An elastic finger is elongated from the adjusting ring and has a tooth engaged with the unidirectional teeth. The tooth moves along the unidirectional teeth when the operating casing is rotated clockwise around the enclosing casing relatively. The tooth is disengaged from the unidirectional teeth by the releasable rib pushing the elastic finger so that the operating casing can be rotated counterclockwise around the enclosing casing relatively.

The enclosing casing has a casing pipe extended from the inner surface of the covering base to pass through the adjusting ring, the operating cylinder, and to enclose the bicycle handle. The operating casing opposite to the functional base has an operating handle thereof for adapting to enclose the casing pipe. The casing pipe has a plurality of protruding hooks at the end thereof for adapting to lock with the operating handle.

The operating handle has a plurality of skidproof textures on the surface.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of an enclosing shift control device for a bicycle transmission of the present invention;

FIG. 2 is an exploded view of the enclosing shift control device for a bicycle transmission from another viewpoint of the present invention;

FIG. 3 is a partial assembled view of the enclosing shift control device for a bicycle transmission of the present invention;

FIG. 4 is an exploded view of the enclosing shift control device for a bicycle transmission of the present invention from another viewpoint for showing an adjusting ring, an enclosing casing and a control wire;

FIG. 5 is an assembled view of the enclosing shift control device for a bicycle transmission of the present invention;

FIG. 6 is a partial perspective view of FIG. 5 for showing an operating casing rotating clockwise around an enclosing casing; and

FIG. 7 is a partial perspective view of FIG. 5 for showing an operating casing rotating counterclockwise around an enclosing casing.

### DETAILED DESCRIPTION OF THE INVENTION

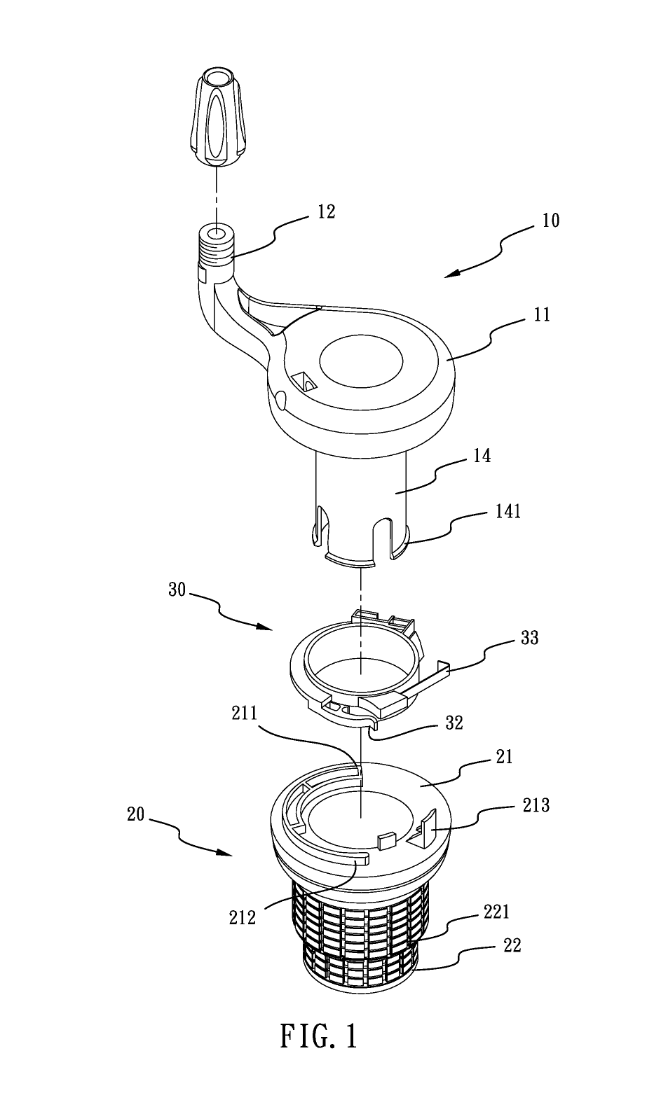

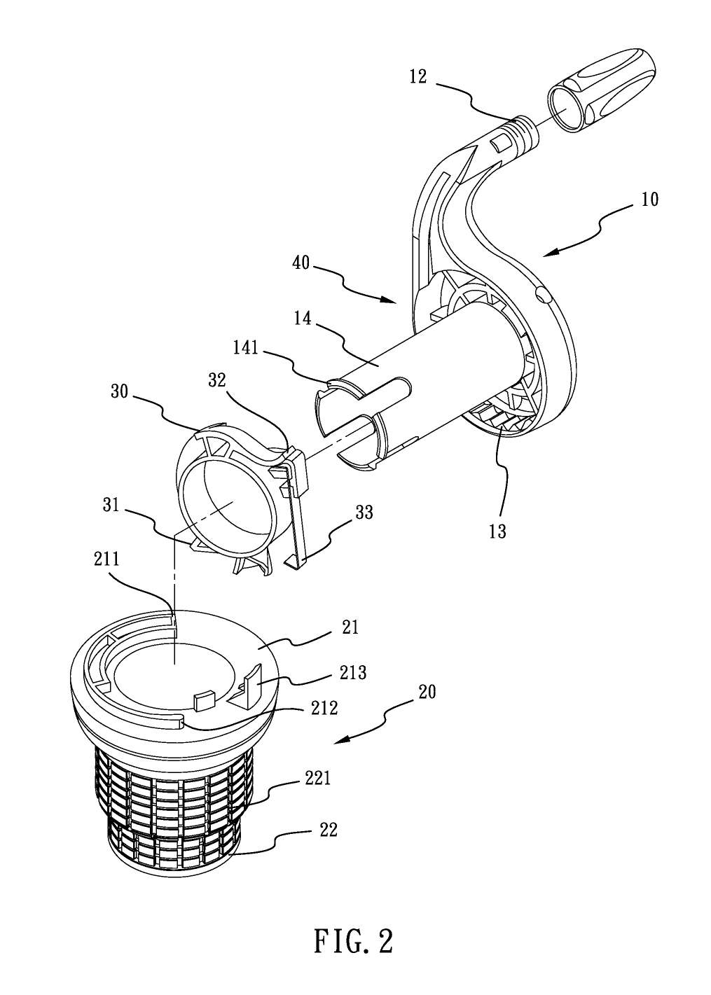

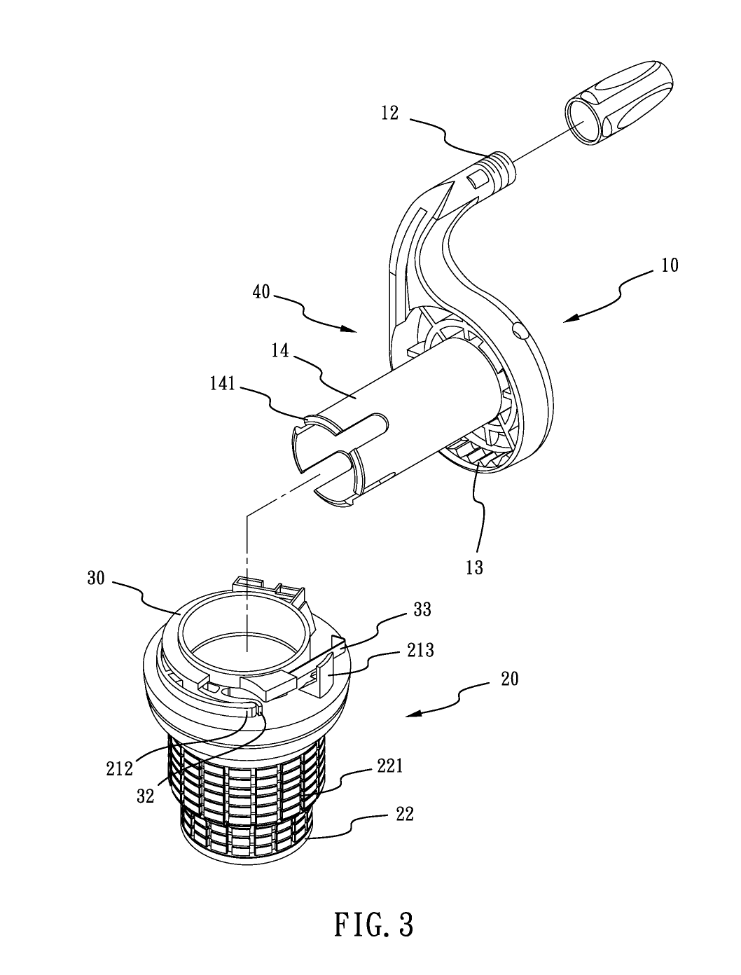

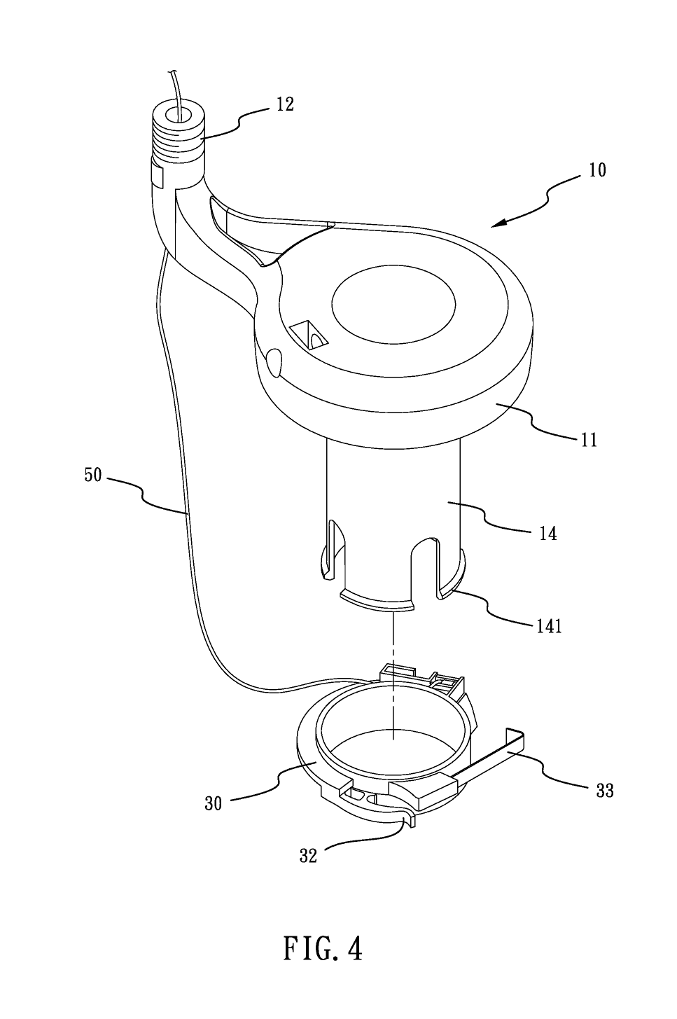

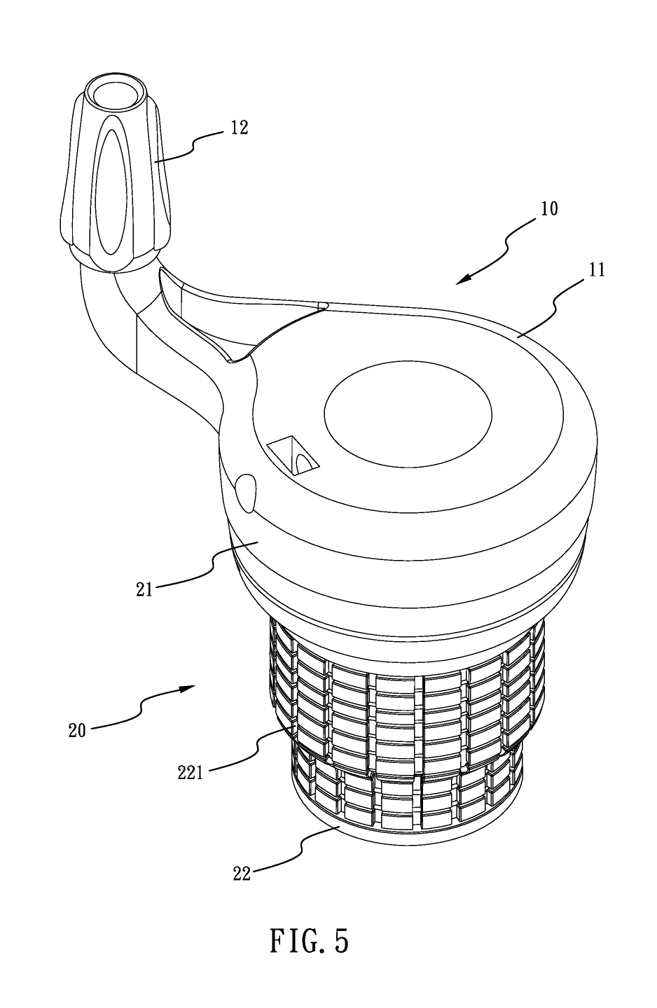

Referring to the drawings to FIGS. 1-7, an enclosing shift control device for a bicycle transmission in accordance with the present invention comprises an enclosing casing 10 adapted to enclose the bicycle handles. The enclosing casing 10 has a covering base 11. The covering base is formed by unfolding one end of the enclosing casing inside out. The covering base 11 has a wire base 12. A control wire 50 adapted to be connected to a derailleur is went through the covering base 11. A plurality of unidirectional teeth 13 is circumferentially aligned around an inner peripheral surface of the covering base 11.

An operating casing 20 is adapted to enclose and rotate freely around the enclosing casing 10. The operating casing 20 has a functional base 21 at one end of the operating casing 20 corresponding to the covering base 11. An accommodating space 40 is formed by the covering base 11 enclosing the functional base 21. A clockwise driving rib 211 is formed on the functional base 21. A counterclockwise driving rib 212 is formed on the functional base 21. A releasable rib 213 is formed on the functional base 21.

An adjusting ring 30 is adapted to connect with the control wire 50 within the accommodating space 40. The adjusting ring 30 has a positioning device 31 thereof for adapting to be driven by the clockwise driving rib 211 rotating clockwise around the enclosing casing 10 relatively. The adjusting ring 30 has an elastic hook 32 attached to the counterclockwise driving rib 212. The elastic hook 22 resists and slows down the counterclockwise driving rib 212 rotating counterclockwise around the enclosing casing 10 relatively. An elastic finger 33 is elongated from the adjusting ring 30 and has a tooth engaged with the unidirectional teeth 13. The tooth guides the elastic finger to move along the unidirectional teeth 13 when the operating casing 20 is rotated clockwise around the enclosing casing 10 relatively. However, the tooth is disengaged from the unidirectional teeth 13 by the releasable rib 213 pushing the elastic finger 33 so that the operating casing 20 can be rotated counterclockwise around the enclosing casing 10 relatively.

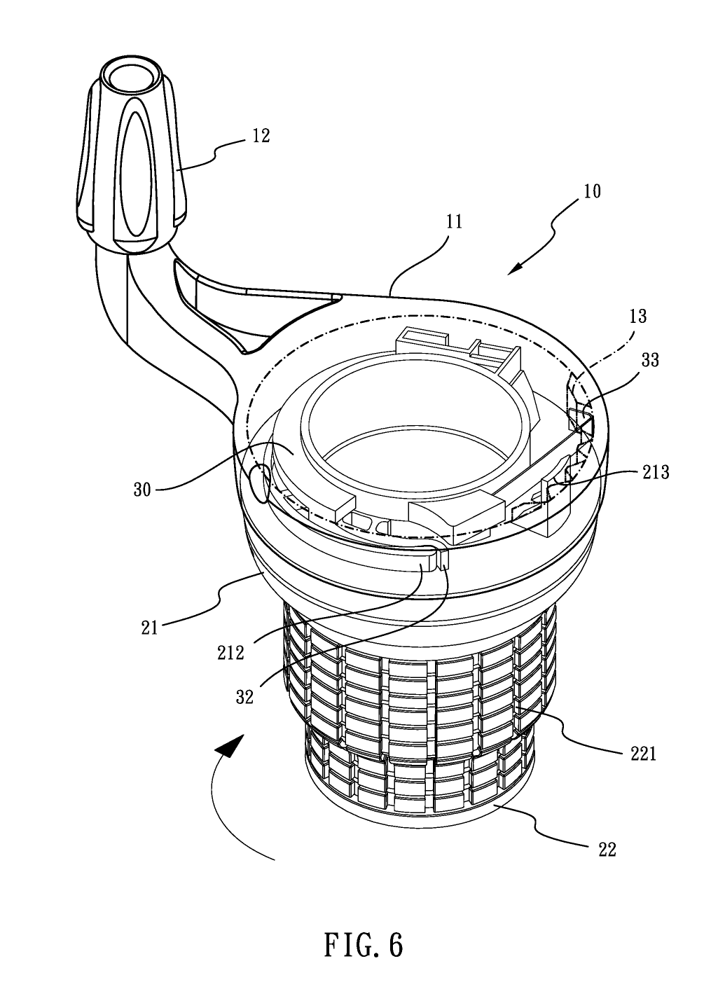

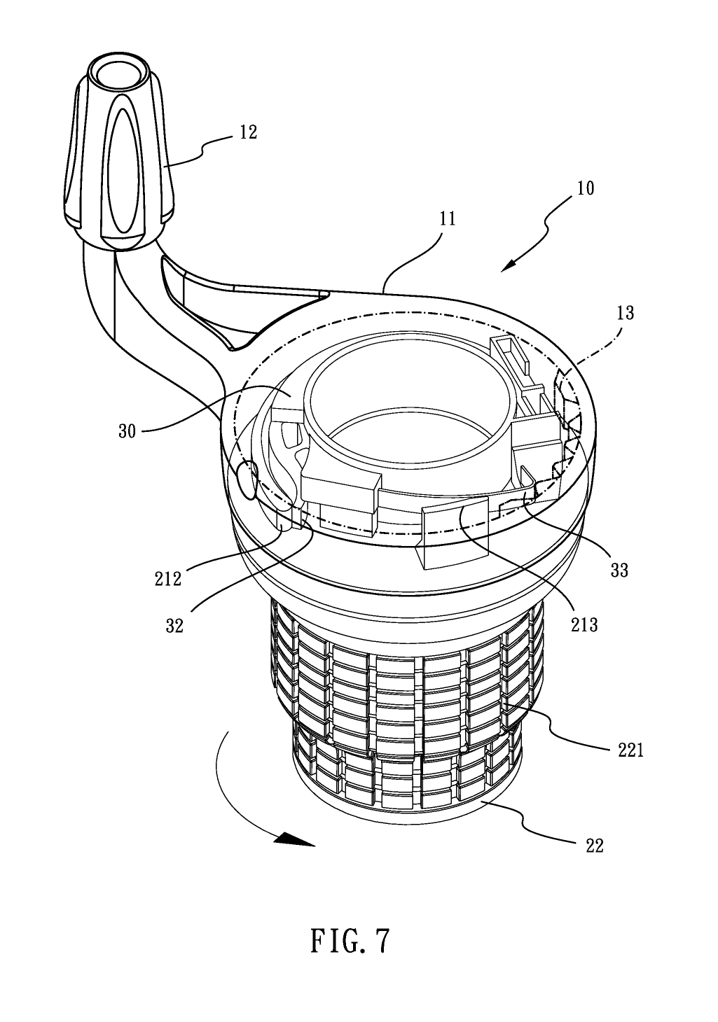

Furthermore, when the operating casing 20 is rotated clockwise around the enclosing casing 10 relatively, the elastic finger 33 is guided by the tooth and moves along the unidirectional teeth 13 thereby the operating casing 20 and the adjusting ring 30 simultaneously rotate clockwise around the enclosing casing 10 relatively. Consequently, the adjusting ring 30 winds the control wire 50 to shift bicycle transmissions from one gear ratio to another (referring to FIG. 6). When the operating casing 20 is stopping rotate clockwise around the enclosing casing 10 relatively, the tooth of the elastic finger 33 is engaged with the unidirectional teeth 13 thereby the control wire 50 would not pull the adjusting ring 30 reversely. When the operating casing 20 is rotated counterclockwise around the enclosing casing 10 relatively, the tooth of the elastic finger 33 is engaged with the unidirectional teeth 13. Therefore the operating case 20 and the adjusting ring 30 are not rotated counterclockwise around the enclosing casing at first. After the force continually imposes on the operating casing 20 to rotate counterclockwise around the enclosing casing 10 relatively, the elastic hook 32 is pushed by the counterclockwise driving rib 212. Consequently, the adjusting ring 30 is rotated slightly by the operating casing 20. The operating casing 20 and the adjusting ring 30 would not rotate simultaneously. Through the slightly rotation between the operating casing 20 and the adjusting ring 30, the releasable rib 213 pushes the elastic finger 33 thereby the tooth of the elastic finger 33 would be disengaged from the unidirectional teeth 13 and the elastic finger 33 would go back along the unidirectional teeth 13 so that the operating casing 20 and the adjusting ring 30 would be rotated counterclockwise around the enclosing casing 10 relatively. Therefore, the adjusting ring 30 unwinds the control wire 50 to shift bicycle transmissions back from one gear ratio to another (referring to FIG. 7).

Furthermore, the enclosing casing 10 has a casing pipe 14 that is extended from the inner surface of the covering base 11 to pass through the adjusting ring 30, the operating casing 20, and to enclose the bicycle handle. The operating casing 20 opposite to the functional base 21 has an operating handle 22 thereof for adapting to enclose the casing pipe 14. The casing pipe 14 has a plurality of protruding hooks 141 at the end thereof for adapting to be locked with the operating handle 22.

Furthermore, the operating handle 22 has a plurality of skidproof textures 221 on the surface, wherein the rider can easily turn the operating casing 20 to shift bicycle transmissions from one gear ratio to another.

Although the invention has been explained in relation to its preferred embodiment, it is to be understood that many other possible modifications and variations can be made without departing from the spirit and scope of the invention as hereinafter claimed.

What is claimed is:

1. An enclosing shift control device for a bicycle transmission comprising:
An enclosing casing adapted to enclose the bicycle handles, the enclosing casing having a covering base wherein the covering base is formed by unfolding one end of the enclosing casing inside out, the covering base having a wire base adapted to providing a control wire through the covering base, a plurality of unidirectional teeth circumferentially aligned around an inner peripheral surface of the covering base;
an operating casing adapted to enclose and rotate around the enclosing casing freely, the operating casing having a functional base at one end of the operating casing corresponding to the covering base, an accommodating space being formed by the covering base enclosing the functional base, a clockwise driving rib formed on the functional base, a counterclockwise driving rib formed on the functional base, a releasable rib formed on the functional base; and
an adjusting ring adapted to connect with the control wire within the accommodating space, the adjusting ring having a positioning device thereof for adapting to be rotated by the clockwise driving rib clockwise relative to the enclosing casing, the adjusting ring having an elastic hook attached to the counterclockwise driving rib, wherein the elastic hook resists and slows down the counterclockwise driving rib rotating counterclockwise around the enclosing casing relatively, an elastic finger elongated from the adjusting ring and having a tooth engaged with the unidirectional teeth, wherein the tooth moves along the unidirectional teeth when the operating casing is rotated clockwise around the enclosing casing relatively, the tooth is disengaged from the unidirectional teeth by the releasable rib pushing the elastic finger such that the operating casing can be rotated counterclockwise around the enclosing casing relatively.

2. The enclosing shift control device for a bicycle transmission as claimed in claim 1, wherein the enclosing casing has a casing pipe extended from the inner surface of the covering base to pass through the adjusting ring, the operating cylinder, and to enclose the bicycle handle; the operating casing opposite to the functional base having an operating handle thereof for adapting to enclose the casing pipe; the casing pipe having a plurality of protruding hooks at the end thereof for adapting to lock with the operating handle.

3. The enclosing shift control device for a bicycle transmission as claimed in claim 2, wherein the operating handle has a plurality of skidproof textures on the surface.
